(19) United States
(12) Patent Application Publication
(10) Pub. No.: US 2005/0218668 A1
(43) Pub. Date: Oct. 6, 2005

(54) Outside handle for door, having easily bendable portion

(75) Inventors: Koichi Sakamoto, Sakura-shi (JP); Yujiro Tashima, Utsunomiya-shi (JP); Makoto Uchikawa, Utsunomiya-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/096,989

(22) Filed: Apr. 1, 2005

(30) Foreign Application Priority Data
Apr. 6, 2004 (JP) 2004-112199

(51) Int. Cl. A47J 45/00

(52) U.S. Cl. 292/336.3

(57) ABSTRACT

An outside handle of a door for vehicles, having a base member; and a handle body coupled with an end portion of the base member in a freely rotatable form. An easily bendable portion is formed in the other end portion of the base member, wherein the easily bendable portion is bendable relatively easily in comparison with the other portions of the base member. Preferably, the easily bendable portion is a thin portion and a transmitting member working with operation of the handle body may be According to the thin portion, the weight of a vehicle or the like can be reduced and the space can be effectively used for arranging functional parts of the outside handle, thereby improving flexibility of design. The easily bendable portion may be a joint portion of two members, a bending portion having a hinge form, or a flexible portion made of a flexible material.

### BACKGROUND OF THE INVENTION

1. Field of the Invention

The present invention relates to an outside handle for doors.

Priority is claimed on Japanese Patent Application No. 2004-112199, filed Apr. 6, 2004, the content of which is incorporated herein by reference.

2. Description of Related Art

In an example of known outside handles for doors of vehicles, an end of the handle body is supported by a base member made of a resin in a freely rotatable form, and the locked door is unlocked by rotating the handle body (see Japanese Unexamined Patent Application, First Publication No. H09-021253). This example will be explained by referring to FIG. 6. Reference numeral 68 indicates a base member made of a resin, which is attached to the back side of a door skin (i.e., an outer panel of a door), and oriented in the front-back direction of a vehicle. Reference numeral 67 indicates a handle body which is provided outside the door skin and is supported at a front portion of the base member 68 in a freely rotatable form. The back edge 69 of the handle body 67 is linked via a link (not shown) to a locking device. Therefore, the door can be opened or closed by pulling the handle body 67 away from the vehicle and then rotating it around the front end 625 (functioning as the center of rotation) of the base member 68. In FIG. 6, reference symbols Fr and Rr respectively indicate the front and the rear of the vehicle, and reference symbols OUT and IN respectively indicate the outside and the inside directions with respect to the vehicle interior.

According to the above conventional outside handle 67 for the door, the door can be opened by a simple operation of pulling the handle body 67 from the outside. However, when external force acts on the door skin and the door skin is deformed toward the inside of the vehicle interior, the front end 625 of the base member 68, following this deformation, is inclined toward the vehicle inside and displaced by a length d (see FIG. 6). If such external force is large and the base member 68 bends toward the vehicle interior, the handle body 67 receives relative rotation force with respect to the base member. In order to prevent this problem, the size of the base member 68 may be increased so as to prevent the base member 68 from bending due to receiving the above rotation force. However, in this case, it is difficult to arrange functional parts of the outside handle, thereby reducing flexibility of design and increasing the weight of the vehicle body.

### SUMMARY OF THE INVENTION

In view of the above circumstances, an object of the present invention is to provide an outside handle of a door of a vehicle, which has reduced size and weight, thereby improving flexibility of design and reducing fuel consumption of the vehicle.

Therefore, the present invention provides an outside handle of a door, comprising:

a base member (e.g., a base member 8 in as embodiment explained later) having two end portions; and

a handle body (e.g., a handle body 7 in the embodiment) coupled with one of the end portions of the base member in a freely rotatable form, wherein

an easily bendable portion (e.g., a thin portion 30 in the embodiment) is formed in the other end portion of the base member, wherein the easily bendable portion is bendable relatively easily in comparison with the other portions of the base member.

According to the structure, when external force acts on a door skin or the like, the base member is drawn toward the inside of the vehicle interior and describes a curve around the easily bendable portion. In this process, an angle between the front portion and the rear portion at either side of the easily bendable portion of the base member is smaller than that in the conventional inclination around a center point closer to the front of the base member. Therefore, it is possible to reduce force for relatively rotating the handle body with respect to the base member.

Typically, the outside handle is used for a vehicle.

Preferably, the easily bendable portion is a thin portion (e.g., the thin portion 30 in the embodiment) whose thickness is less than those of the other portions (e.g., a normal portion 33 in the embodiment). According to the thin portion, the weight of a vehicle or the like can be reduced.

In this case, a transmitting member (e.g., a link 19 in the embodiment) working with an operation of the handle body may be provided in a space (e.g., a space S in the embodiment) produced by the thin portion. Therefore, the space can be effectively used for providing such a transmitting member. Accordingly, it is easy to arrange functional parts of the outside handle, thereby improving flexibility of design.

The easily bendable portion may be a joint portion of two members, a bending portion having a hinge form, or a flexible portion made of a flexible material.

### BRIEF DESCRIPTION OF THE DRAWINGS

FIG. 1 is a perspective view showing a vehicle in an embodiment of the present invention.

FIG. 2 is a perspective view showing the outside handle in the embodiment.

FIG. 3 is a diagram viewed from a perspective indicated by an arrow A in FIG. 2.

FIG. 4 is a sectional view along lines B in FIG. 2.

FIG. 5 is a side view of the outside handle in the embodiment.

FIG. 6 is a side view of a conventional outside handle, the view corresponding to FIG. 5.

### DETAILED DESCRIPTION OF THE INVENTION

Hereinafter, embodiments according to the present invention will be explained with reference to the drawings.

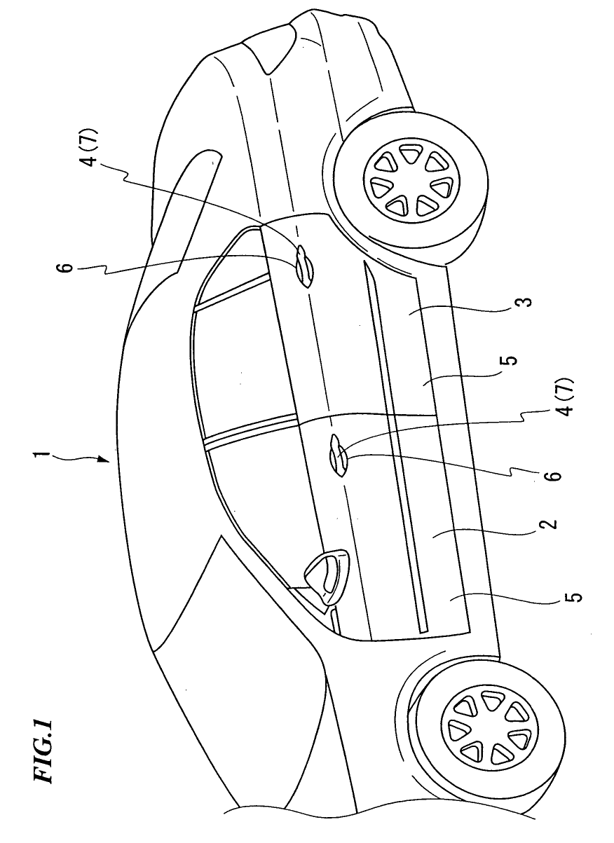

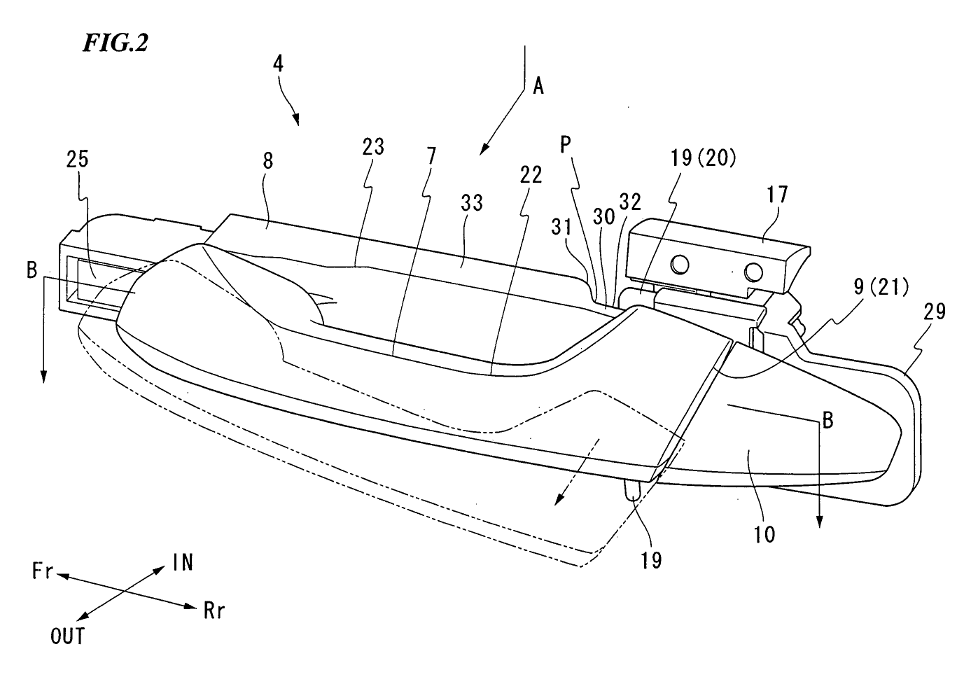

FIG. 1 is a perspective view showing a vehicle in an embodiment of the present invention. As shown in the figure, outside handles 4 are respectively attached to a front door 2 and a rear door 3 of a vehicle 1. In the outside handle 4, a handle body 7 is arranged in a concave portion 6 which is provided in a door skin 5 (i.e., an outer panel of the door) and the front end of the handle body 7 is supported at the front side of a base member 8 in a freely rotatable form (see FIG. 2, which is a perspective view showing the outside handle), where the base member 8 is arranged at the interior surface (i.e., the side facing the vehicle interior) of the door skin 5.

As shown in FIG. 2, the back edge 9 of the handle body 7 of the outside handle 4 is joined to a decorative member 10 which is attached to the base member 8. When the handle body 7 is operated, the back edge 9 can be pulled out away from the vehicle in a fixed path, while the decorative member 10 remains at the original position.

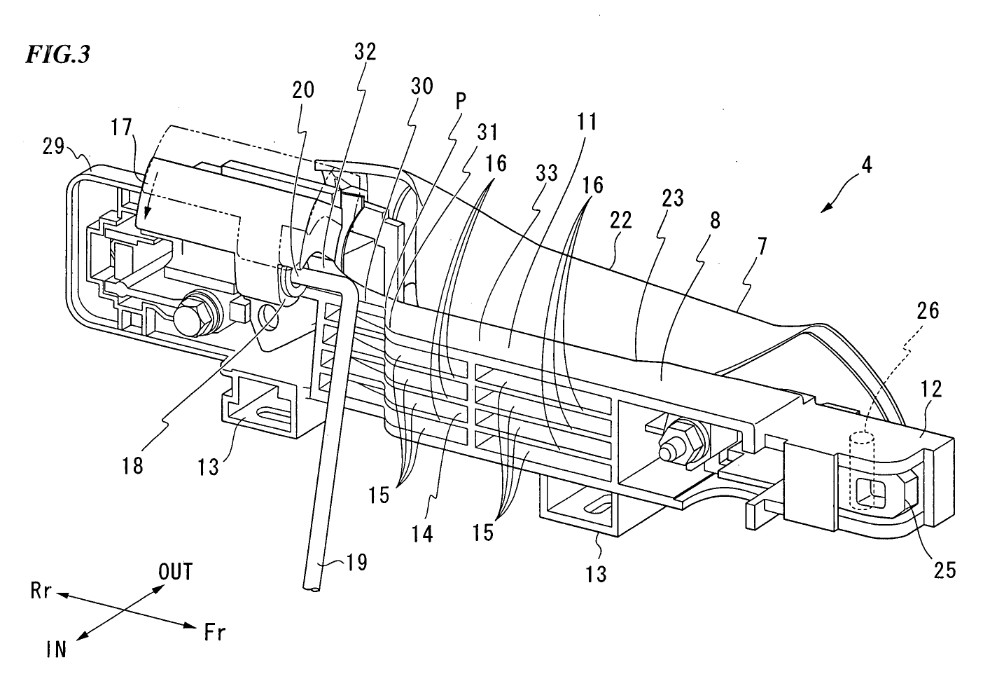

This operation will be specifically explained by referring to FIGS. 2 and 3. FIG. 3 is a diagram viewed from a perspective indicated by an arrow A in FIG. 2. In FIGS. 2 and 3, reference symbols Fr and Rr respectively indicate the front and the rear of the vehicle, and reference symbols OUT and IN respectively indicate the outside and the inside directions with respect to the vehicle interior (similar definitions are applied to FIG. 5).

The base member 8 is a resin member formed by injection molding or the like. As shown in FIG. 3, the base member 8 consists of a main body 11 and a hinge support 12 provided at the front end of the main body 11. At the lower side of the main body 11, two attachment portions 13 and 13 are provided in the front-rear direction of the vehicle and are fastened to the main body of the door. In addition, a plurality of grooves 15 are formed in an inner face 14 so as to reduce weight. According to the grooves 15, a plurality of ribs 16 extending in the front-rear direction are produced, where each rib has upper and lower rib faces, thereby improving strength and rigidity with respect to deformation of the main body 11 toward the outside or the inside of the vehicle interior.

At the rear end of the base member 8, an arm member 17 is provided, which rotates in a direction indicated by a chain-line arrow in FIG. 3, where this rotation is linked with the pulling operation of the handle body 7. The arm member 17 has a lower end attachment portion 18, at which an upper end fitting portion 20 of a link 19 (i.e., a transmitting member) is supported in a freely rotatable form. The link 19 is linked with a door locking device (not shown).

As shown in FIG. 2, at the outside of the base member 8 (i.e., at the face which faces the outside of the vehicle), the above-described handle body 7, whose front end 25 is inserted into the hinge support 12, is provided, where the handle body 7 can be freely rotated away from the vehicle. The rear edge 9 of the handle body 7 has a cut face 21 arranged at an oblique angle in a front-lower direction. The decorative member 10 is attached to the main body 11 of the base member 7, where the decorative member 10 has a substantially conical shape which matches the cut face 21 and the outer shape of the handle body 7. Therefore, the handle body 7 and the decorative member 10, which is attached adjoining the rear edge 9 of the handle body 7 produce a streamline shape.

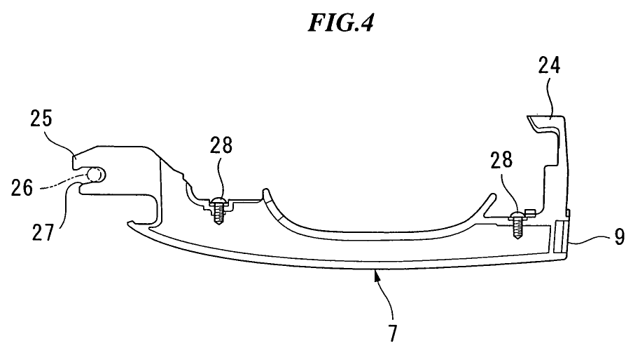

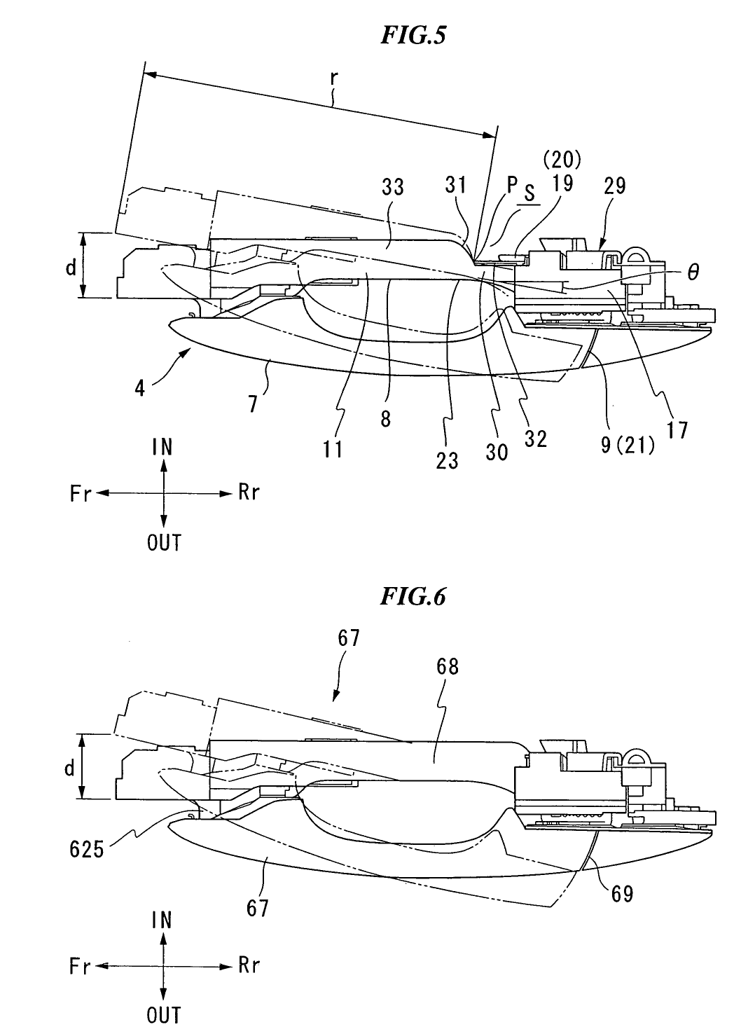

In the upper face of the handle body 7, a concave portion 22 is formed toward the lower side. Owing to this concave portion 22 and another concave portion 23 which is formed in the outside face (which faces the outside of vehicle) of the base member 8, a person can easily insert a hand so as to operate the outside handle. In addition, the grip of the handle body 7 is thinner in comparison with the front and rear portions, so that the grip can be easily grasped. FIG. 4 is a sectional view along lines B in FIG. 2. As shown in FIG. 4, the rear edge 9 of the handle body 7 extends toward the vehicle interior, and a hook 24 is provided at the end of the rear edge 9. This hook 24 is inserted into an engagement portion (not shown) formed in a rear portion of the base member 8. Therefore, when rotating the handle body 7 away from the vehicle (see the chain line in FIG. 2), the handle body 7 does not come out from the base member 8. As shown in FIG. 4, in the front end 25 of the handle body 7, a concave portion 27 is formed, with which the pin 26 of the hinge support 12 of the base member 8 is engaged. Additionally, in order to effectively use the inside space of the handle body 7 as a passage for arranging a harness, the handle body 7 can be divided into two portions, which are attached by screws 28 and 28.

FIG. 5 is a side view of the outside handle 4 in the present embodiment. As shown in FIG. 5, a thin portion 30 which can be easily bent is provided in a rear portion of the base member 8 and at a joint portion between an arm body support 29 for supporting the arm member 17 and the main body 11 of the base member 8. In addition, this thin portion 30 is formed between (i) the concave portion 23 provided in the outside face (which faces the outside of the vehicle) of the base member 8 and (ii) the inside face (which faces the inside of the vehicle interior) of the base member 8. That is, in the inside face of the base member 8, an arc portion 31 extending away from the vehicle is provided at a joint portion between the arm body support 29 and the main body 11 of the base member 8, and a linear portion 32 extending from the end of the arc portion 31 is also provided. The thin portion 30 having a thickness less than that of the normal portion 33 is formed at a bending point P, between the arc portion 31 and the linear portion 32.

When external force acts from the outside of the vehicle on the door skin 5 of the front door 2 or the rear door 3 to which the outside handle 4 is attached, and the door skin 5 is drawn toward the inside of the vehicle interior and is deformed, a front portion of the base member 8 of the outside handle 4 inclines toward the inside of the vehicle interior by angle θ around the bending point P.

Therefore, in this embodiment, when external force acts on a center portion of the door body, which can be more easily deformed in comparison with peripheral portions of the door body, the base member 8 receives force and is drawn into the vehicle interior in accordance with deformation of the door skin 5. Accordingly, a front portion of the base member 8 is forced to bend and deform toward the vehicle interior by length d (see FIG. 5). In this process, the base member 8 describes a curve around the bending point P with a radius r, that is, with a span longer than that in the conventional structure, and at a smaller inclination angle θ. Therefore, it is possible to reduce the amount of countermovement (away from the vehicle) of the rear portion of the outside handle 4 and to prevent the locking device from unlatching due to the countermovement.

In addition, owing to the thin portion 30 in the base member 8, the weight of the outside handle can be reduced, thereby reducing the weight of the vehicle body and also reducing fuel consumption.

Furthermore, as shown in FIGS. 3 and 5, the space S formed by the arc portion 31 and the linear portion 32 in the inside face of the base member 8 can be effectively used for arranging the link 19. Therefore, in comparison with the case in which the link 19 is arranged in another portion, the size of the outside handle 4 can be reduced and flexibility for arranging other peripheral parts can be improved; thus, a wider space for arranging functional parts can be secured in the door body.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, instead of the thin portion which can be easily bent, (i) a joint portion (of two members) which can also be easily bent, (ii) a bending portion having a hinge form which can be positively bent, or (iii) a flexible portion made of a flexible (or relatively fragile) material, may be provided at a relevant portion.

1. An outside handle of a door, comprising:
a base member having two end portions; and
a handle body coupled with one of the end portions of the base member in a freely rotatable form, wherein
an easily bendable portion is formed in the other end portion of the base member, wherein the easily bendable portion is bendable relatively easily in comparison with the other portions of the base member.

2. The outside handle as claimed in claim 1, wherein the easily bendable portion is a thin portion whose thickness is less than those of the other portions.

3. The outside handle as claimed in claim 1, wherein the easily bendable portion is a joint portion of two members.

4. The outside handle as claimed in claim 1, wherein the easily bendable portion is a bending portion having a hinge form.

5. The outside handle as claimed in claim 1, wherein the easily bendable portion is a flexible portion made of a flexible material.

6. The outside handle as claimed in claim 2, wherein a transmitting member working with an operation of the handle body is provided in a space produced by the thin portion.

7. The outside handle as claimed in claim 1, which is used for a vehicle.
